(19) United States
(12) Patent Application Publication
(10) Pub. No.: US 2024/0172573 A1
(43) Pub. Date: May 30, 2024

(54) Handheld Tilling Device

(71) Applicant: Richard Prato, Aldergrove (CA)

(72) Inventor: Richard Prato, Aldergrove (CA)

(21) Appl. No.: 18/450,458

(22) Filed: Aug. 16, 2023

Related U.S. Application Data
(60) Provisional application No. 63/428,438, filed on Nov. 29, 2022.

(51) Int. Cl. A01B 1/06; A01B 1/08

(52) U.S. Cl. CPC A01B 1/065; A01B 1/08

(57) ABSTRACT

The present invention relates to a handheld tilling device. The device can be used to till small garden beds via a handheld, motorized device. The device is primarily comprised of at least one handle, at least one leveling plate, at least one blade, and at least one motor. During use, the device can be used in a handheld manner to till the soil in row-like patterns.

### CROSS-REFERENCE TO RELATED APPLICATION

The present application claims priority to, and the benefit of, U.S. Provisional Application No. 63/428,438, which was filed on Nov. 29, 2022, and is incorporated herein by reference in its entirety.

### FIELD OF THE INVENTION

The present invention relates generally to the field of soil-tilling devices. More specifically, the present invention relates to a handheld tilling device that can be used to till small garden beds via a handheld, motorized device. Accordingly, the present disclosure makes specific reference thereto. Nonetheless, it is to be appreciated that aspects of the present invention are also equally applicable to other like applications, devices, and methods of manufacture.

### BACKGROUND

Tilling garden beds can be a difficult and time-consuming task. Most individuals till garden beds by hand, which can be tiresome and physically taxing. In addition, due to the size of small garden beds, the usage of heavy-duty tilling machinery may be impractical.

Therefore, there exists a long-felt need in the art for an improved soil-tilling device. More specifically, there exists a long-felt need in the art for a handheld tilling device for use with small garden beds. In addition, there exists a long-felt need in the art for a handheld tilling device for use with small garden beds wherein the device is a handheld device. Furthermore, there exists a long-felt need in the art for a handheld tilling device for use with small garden beds wherein the device is a handheld device that tills soil via a mechanical process.

The subject matter disclosed and claimed herein, in one embodiment thereof, comprises a handheld tilling device. The device is primarily comprised of at least one handle, at least one leveling plate, at least one blade, and at least one motor. The device is intended to be used as a handheld tilling device for personal gardens or other small areas. During use, the device can be placed on a soil surface wherein the leveling plate ensures the device remains level. Then, the trigger can be pulled, such that the motor spins the blade which tills the soil underneath the device. A user can then push the device through the soil to easily till soil in row patterns.

In this manner, the handheld tilling device of the present invention accomplishes all the foregoing objectives and provides an improved soil-tilling device. The device can be used to till the soil in a small garden bed. In addition, the device can easily be used in a handheld manner. Further, the device tills soil via a mechanical process that involves minimal physical effort from the user.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a handheld tilling device primarily comprised of at least one handle, at least one leveling plate, at least one blade, and at least one motor. The device is intended to be used as a handheld tilling device for personal gardens or other small areas. The device is comprised of at least one handle that allows a user to control the direction of the device. The handle is also comprised of at least one trigger that activates the motor to spin at least one axle with at least one blade attached.

The blade of the device is partially covered by at least one housing that prevents the blade from cutting a user during use and prevents soil and/or other debris from hitting the user. The housing may also be comprised of at least one secondary handle that allows a user to place their other hand on the device for further control. The housing may also be comprised of at least one leveling plate that provides a flat surface to rest atop the soil while the device is being used to till the soil.

The device is comprised of at least one blade. In one embodiment, a plurality of blades are fixedly attached to one connecting member, wherein the blades are radially disposed around the connecting member. The connecting member is comprised of at least one opening that allows the blade to be placed on at least one axle. The blade is secured on the axle via at least one fastener on each side of the blade. In one embodiment, the axle is threaded to receive a threaded fastener. One end of the axle is secured within the housing to the motor. During use, the motor spins the axle to spin the blade, which in turn tills soil the blade contacts.

The present invention is also comprised of a method of using the device. First, a device is provided comprised of at least one handle, at least one leveling plate, at least one blade, and at least one motor. Then, a blade is secured to an axle via a fastener. Next, the device can be placed on the soil while the trigger is pulled to activate the motor. As the motor spins the axle (which spins the blade), the blade can be pushed into the soil such that the leveling plate rests on the soil. Then, the user can push the device through the soil to till the soil.

Accordingly, the handheld tilling device of the present invention is particularly advantageous as it provides an improved soil-tilling device. The device can be used to till the soil in a small garden bed. In addition, the device can easily be used in a handheld manner. Further, the device tills soil via a mechanical process that involves minimal physical effort from the user. In this manner, the handheld tilling device provides a solution to tilling small garden beds via a mechanical device.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a handheld tilling device of the present invention in accordance with the disclosed architecture;

FIG. 2 illustrates a side view of a blade of one potential embodiment of a handheld tilling device of the present invention in accordance with the disclosed architecture;

FIG. 3 illustrates a perspective view of one potential embodiment of a handheld tilling device of the present invention being used to till the soil in accordance with the disclosed architecture; and

FIG. 4 illustrates a flowchart of a method of using one potential embodiment of a handheld tilling device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved soil-tilling device. More specifically, there exists a long-felt need in the art for a handheld tilling device for use with small garden beds. In addition, there exists a long-felt need in the art for a handheld tilling device for use with small garden beds wherein the device is a handheld device. Furthermore, there exists a long-felt need in the art for a handheld tilling device for use with small garden beds wherein the device is a handheld device that tills soil via a mechanical process.

The present invention, in one exemplary embodiment, is comprised of a handheld tilling device primarily comprised of at least one handle, at least one leveling plate, at least one blade, and at least one motor. The device is intended to be used as a handheld tilling device for personal gardens or other small areas. The device is comprised of at least one handle that allows a user to control the direction of the device. The handle is also comprised of at least one trigger that activates the motor to spin at least one axle with at least one blade attached.

The blade of the device is partially covered by at least one housing. This prevents the blade from cutting a user during use and prevents soil and/or other debris from hitting the user. The housing may also be comprised of at least one secondary handle that allows a user to place their other hand on the device for further control. The housing may also be comprised of at least one leveling plate that provides a flat surface to rest atop the soil while the device is being used to till the soil.

The device is comprised of at least one blade. In one embodiment, a plurality of blades are fixedly attached to one connecting member. In this embodiment, the blades are radially disposed around the connecting member. The connecting member is comprised of at least one opening that allows the blade to be placed on at least one axle. The blade is secured on the axle via at least one fastener on each side of the blade. In one embodiment, the axle is threaded to receive a threaded fastener. One end of the axle is secured within the housing to the motor. During use, the motor spins the axle to spin the blade, which in turn, tills soil the blade contacts.

The present invention is also comprised of a method of using the device. First, a device is provided comprised of at least one handle, at least one leveling plate, at least one blade, and at least one motor. Then, a blade is secured to an axle via a fastener. Next, the device can be placed on the soil while the trigger is pulled to activate the motor. As the motor spins the axle (which spins the blade), the blade can be pushed into the soil such that the leveling plate rests on the soil. Then, the user can push the device through the soil to till the soil.

Accordingly, the handheld tilling device of the present invention is particularly advantageous as it provides an improved soil-tilling device. The device can be used to till the soil in a small garden bed. In addition, the device can easily be used in a handheld manner. Further, the device tills soil via a mechanical process that involves minimal physical effort from the user. In this manner, the handheld tilling device provides a solution to tilling small garden beds via a mechanical device.

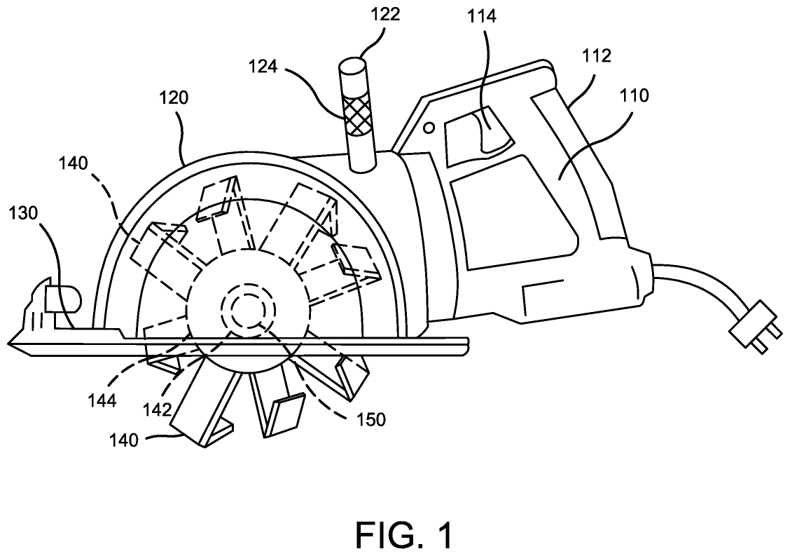

Referring initially to the drawings, FIG. 1 illustrates a side view of one potential embodiment of a handheld tilling device 100 of the present invention in accordance with the disclosed architecture. The device 100 is primarily comprised of at least one handle 110, at least one leveling plate 130, at least one blade 140, and at least one motor 170. The device 100 is intended to be used as a handheld tilling device for personal gardens or other small areas.

The device 100 is comprised of at least one handle 110. During use, a user grips the handle to control the direction of the device 100. The handle 110 may be comprised of at least one grip 112. The grip 112 may be a textured (i.e., raised texture or recessed texture) or non-textured. The grip 112 is preferably made from a non-slip rubber material that promotes grip. The handle 110 is also comprised of at least one trigger 114. Pulling the trigger 114 activates the motor 170 to spin at least one axle 150 with at least one blade 140 attached.

The blade 140 of the device 100 is partially covered by at least one housing 120. The housing 120 prevents the blade 140 from cutting a user during use and prevents soil 10 and/or other debris from hitting the user. The housing 120 may also be comprised of at least one secondary handle 122. The secondary handle 122 allows a user to place their other hand on the device 100 for further control. In one embodiment, the handle 122 is comprised of at least one grip 124. The grip 124 may be a textured (i.e., raised texture or recessed texture) or non-textured. The grip 124 is preferably made from a non-slip rubber material that promotes grip. Both handles 110,122 may be any ergonomic shape known in the art.

The housing 110 may also be comprised of at least one leveling plate 130. The plate 130 is preferably fixedly attached to the housing 120. The plate 130 provides a flat surface to rest atop soil 10 while the device is being used to till the soil 10.

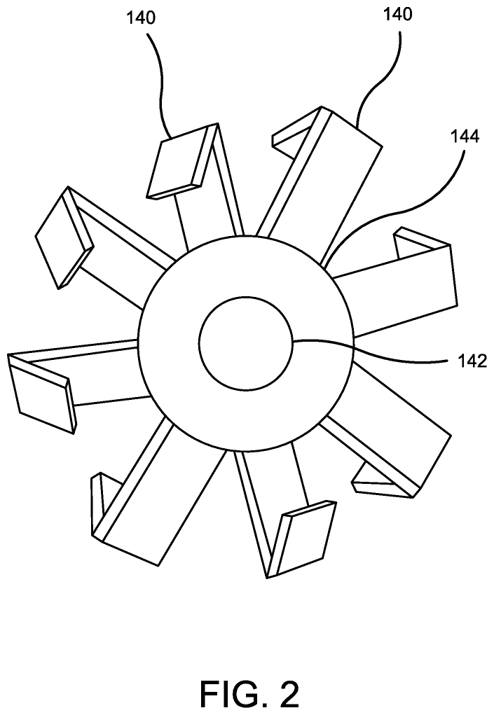

The device 100 is comprised of at least one blade 140 preferably made from a durable metal material, as seen in FIG. 2. In one embodiment, the blade 140 is comprised of a flat blade. In another embodiment, the device 10 is comprised of a blade 140 that forms an acute angle. In one embodiment, a plurality of blades 140 are fixedly attached to one connecting member 144, wherein the blades 140 are radially disposed around the connecting member 144. However, the blade 140 may be any shape, size, and configuration for optimized soil 10 tilling.

The connecting member 144 is comprised of at least one opening 142 that allows the blade 140 to be placed on at least one axle 150. In this manner, a user can add or subtract blades 140 depending on how much soil 10 and/or how many rows of soil 10 they desire to till. The blade 140 is secured on the axle 150 via at least one fastener 160 on each side of the blade 140. The fastener 160 is preferably, but not limited to, a clip, a pin, a nut, etc. The fasteners 160 may also serve as spacers between a plurality of blades 140 on the axle 150. In one embodiment, the axle 150 is threaded to receive a threaded fastener 160. One end of the axle 150 is secured within the housing 120 to the motor 170.

During use, the motor 170 spins the axle 150 to spin the blade 140, which in turn, tills soil 10 the blade 140 contacts. The motor 170 may be any type of electric motor known in the art and is powered by at least one battery 180. In one embodiment, the battery 180 is comprised of a removable battery that can be recharged via any rechargeable battery charging means known in the art. In another embodiment, the body 110 is fixedly attached to the device 100 and receives power via at least one power cord 190 such as, but not limited to, a 110v/220v power cord.

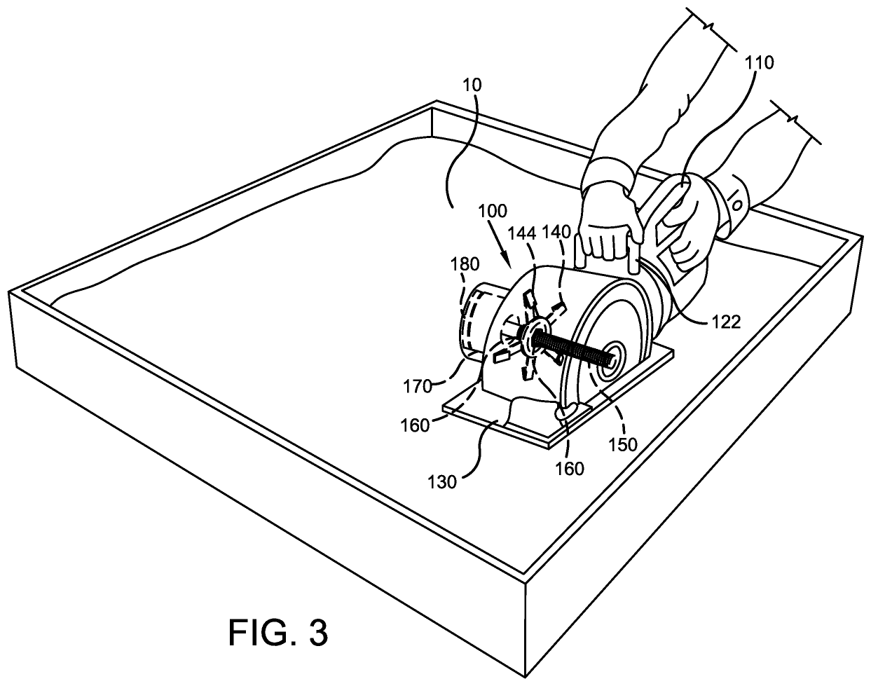

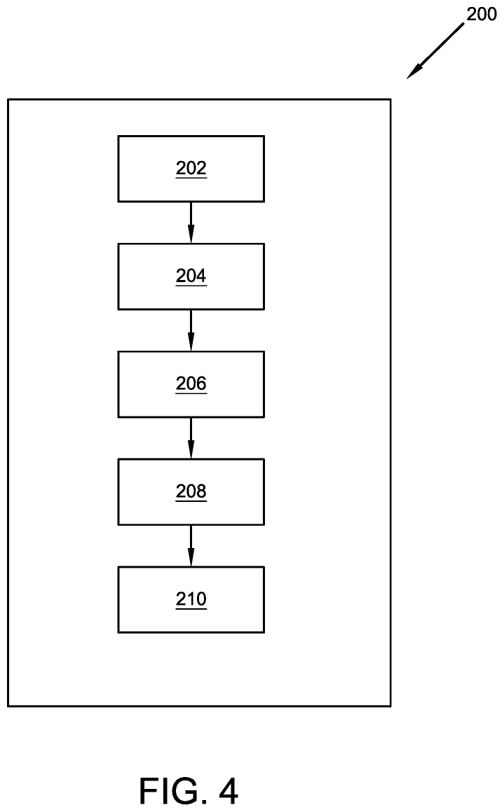

The present invention is also comprised of a method of using 200 the device 100, as seen in FIG. 4. First, a device 100 is provided comprised of at least one handle 110, at least one leveling plate 130, at least one blade 140, and at least one motor 170 [Step 202]. Then, a blade 140 is secured to an axle 150 via a fastener 160 [Step 204]. Next, the device 100 can be placed on soil 10 while the trigger 114 is pulled to activate the motor 170 [Step 206]. As the motor 170 spins the axle 150 (which spins the blade 140), the blade 140 can be pushed into the soil 10 such that the leveling plate 130 rests on the soil, as seen in FIG. 3 [Step 208]. Then, the user can push the device 100 through the soil 10 to till the soil 10 while pulling the trigger 114 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “handheld tilling device” and “device” are interchangeable and refer to the handheld tilling device 100 of the present invention.

Notwithstanding the foregoing, the handheld tilling device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the handheld tilling device 100 as shown in the FIGS. are for illustrative purposes only, and that many other sizes and shapes of the handheld tilling device 100 are well within the scope of the present disclosure. Although the dimensions of the handheld tilling device 100 are important design parameters for user convenience, the handheld tilling device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A handheld tilling device comprising:
a handle comprised of a trigger;
a housing;
an axle attached to a motor;
a blade attached to a connecting member;
a fastener; and
a battery.

2. The handheld tilling device of claim 1, wherein the blade is comprised of a flat blade.

3. The handheld tilling device of claim 1, wherein the trigger activates the motor.

4. The handheld tilling device of claim 1, wherein the axle is comprised of a threaded axle.

5. The handheld tilling device of claim 1, wherein the fastener is comprised of a nut.

6. The handheld tilling device of claim 1, wherein the housing is comprised of a leveling plate.

7. The handheld tilling device of claim 1, wherein the battery is comprised of a removable battery.

8. The handheld tilling device of claim 1, wherein the handle is comprised of a grip.

9. The handheld tilling device of claim 1, wherein the connecting member is comprised of an opening.

10. A handheld tilling device comprising:
a handle comprised of a trigger;
a housing;
an axle attached to a motor;
a first blade attached to a connecting member comprised of an opening;
a fastener;
a battery; and
a power cord.

11. The handheld tilling device of claim 10, wherein the first blade is comprised of an angled blade.

12. The handheld tilling device of claim 11, wherein the angled blade forms an acute angle.

13. The handheld tilling device of claim 10, wherein the axle is comprised of a threaded axle.

14. The handheld tilling device of claim 10, wherein the fastener is comprised of a nut.

15. The handheld tilling device of claim 10, wherein the power cord is comprised of a 110v power cord.

16. The handheld tilling device of claim 10, wherein the housing is comprised of a secondary handle.

17. The handheld tilling device of claim 10 further comprised of a second blade attached to the connecting member.

18. A method of using a handheld tilling device, the method comprising the steps of:
providing a handheld tilling device comprised of a handle, a leveling plate, a blade, and a motor;
securing the blade to an axle of the handheld tilling device via a fastener;
placing the handheld tilling device on a soil while pressing a trigger of the handheld tilling device;
pushing the blade into the soil such that the leveling plate rests on the soil; and
pushing the handheld tilling device through the soil while pulling the trigger.

19. The method of claim 18, wherein the blade is comprised of a straight blade.

20. The method of claim 18, wherein the blade is comprised of an angled blade.
